(19) United States
(12) Patent Application Publication
(10) Pub. No.: US 2015/0130310 A1
(43) Pub. Date: May 14, 2015

(54) MOTOR

(71) Applicant: Nidec Corporation, Minami-ku, Kyoto (JP)

(72) Inventors: Takashi Shiraishi, Kyoto (JP); Takahiro Hiwa, Kyoto (JP); Shohei Osuga, Kyoto (JP)

(21) Appl. No.: 14/399,257

(22) PCT Filed: May 17, 2013
(86) PCT No.: PCT/JP2013/003162

§ 371 Date: Nov. 6, 2014

(30) Foreign Application Priority Data
May 22, 2012 (JP) 2012-116844

(51) Int. Cl. H02K 5/14; H02K 5/10

(52) U.S. Cl. CPC H02K 5/14; H02K 5/10
USPC 310/88

(57) ABSTRACT

A motor includes a housing, a back cover, a brush card, and a brush. The brush card is disposed in a casing defined by the housing and the back cover. The brush is disposed on a front side of the brush card. The back cover includes a through-hole in the vicinity of a lower end portion of a first circumferential wall portion. The back cover and the brush card are in contact with each other in an annular or substantially annular shape, in a radially inner side of an inner circumferential surface of the first circumferential wall portion via a gap. The contact portion is disconnected, or the brush card is radially penetrated, at a position that radially overlaps with the through-hole.

### BACKGROUND OF THE INVENTION

1. Field of the Invention

The present invention relates to a motor.

2. Description of the Related Art

Hitherto, a motor having a brush is known. The structure of the motor having the brush is disclosed in, for example, Japanese Patent Publication No. 3971349. The motor in the Japanese Patent Publication No. 3971349 includes a rotatable armature and a brush that is in sliding contact with a commutator of the armature (Paragraphs [0018] and [0019] of Japanese Patent Publication No. 3971349). In addition, the brush in Japanese Patent Publication No. 3971349 is connected to an external power source, and supplies electric power to the armature via the commutator (Paragraph [0019] of Japanese Patent Publication No. 3971349).

There may be a case where the motor having the brush is used in an environment in which liquid droplets are likely to be present, for example, the inside of a vehicle. In this case, it is preferable that liquid droplets be prevented from, at least, adhering to the brush which is a conductor. To achieve this, it is necessary to efficiently discharge the droplet from the inside of a cover which accommodates the brush. In particular, in a case where a brush card that supports the brush is disposed inside the cover, it is necessary to secure drainage so that the droplet does not remain in the brush card.

### SUMMARY OF THE INVENTION

According to an exemplary preferred embodiment of the present invention, a motor includes a rotating portion, a housing, a back cover, a brush card, and a brush. The rotating portion extends horizontally or substantially horizontally in a front-rear direction and is supported to be rotatable centered on a central axis. The rotating portion includes a commutator. The housing is cup-shaped or substantially cup-shaped and accommodates at least a portion of the rotating portion. The back cover is disposed rear of the housing. The back cover is cup-shaped or substantially cup-shaped and together with the housing, defines a casing. The brush card is disposed in the casing. The brush card extends in a direction orthogonal or substantially orthogonal to the central axis. The brush is disposed forward of the brush card. The brush is in contact with the commutator. The back cover includes a first rear wall portion, a first circumferential wall portion, and a through-hole. The first rear wall portion extends in the direction orthogonal or substantially orthogonal to the central axis in a rear side of the brush card. The first circumferential wall portion is of a cylindrical or substantially cylindrical shape. The first circumferential wall portion extends forward from an outer peripheral portion of the first rear wall portion. The through-hole vertically penetrates through the first circumferential wall portion in the vicinity of a lower end portion of the first circumferential wall portion. The back cover or the brush card includes a contact portion of a annular or substantially annular shape at which the back cover and the brush card are in contact. The back cover and the brush card are in contact with each other in a radially inner side of an inner circumferential surface of the first circumferential wall portion via a gap. The contact portion is disconnected at a position which radially overlaps with the through-hole. Or, the brush card is penetrated radially outward from the radially inner side than the contact portion at the position which radially overlaps with the through-hole.

According to the motor of the first exemplary preferred embodiment of the present invention, both a droplet that has infiltrated between the first circumferential wall portion and the contact portion and a droplet that has infiltrated radially inside the contact portion flow along an inner surface of the back cover and are discharged outside the back cover through the through-hole. Thus, the motor is capable of efficiently discharging the droplet from the inside of the back cover. As a result, the motor is capable of significantly reducing or preventing the droplets that adhere to the brush.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a longitudinal cross-sectional view of a motor according to a first preferred embodiment of the present invention.

FIG. 2 is a view of the inside of the motor according to the first preferred embodiment of the present invention, viewed from the front.

FIG. 3 is a longitudinal cross-sectional view of a motor according to a second preferred embodiment of the present invention.

FIG. 4 is a view of a back cover, a brush card, and a connector member according to the second preferred embodiment of the present invention, viewed from the front.

FIG. 5 is a longitudinal cross-sectional view of the back cover, the brush card, and the connector member according to the second preferred embodiment of the present invention.

FIG. 6 is a top view of the connector member according to the second preferred embodiment of the present invention.

FIG. 7 is a view of the connector member according to the second preferred embodiment of the present invention, viewed from the front.

FIG. 8 is a bottom view of the connector member according to the second preferred embodiment of the present invention.

FIG. 9 is a view of the back cover according to the second preferred embodiment of the present invention, viewed from the front.

FIG. 10 is a partial transverse cross-sectional view of a housing, the back cover, the brush card, and the connector member according to the second preferred embodiment of the present invention.

FIG. 11 is a partial cross-sectional view of the housing, the back cover, and the brush card according to the second preferred embodiment of the present invention.

FIG. 12 is a partial longitudinal cross-sectional view of the housing, the back cover, and the brush card according to the second preferred embodiment of the present invention.

FIG. 13 is a partial longitudinal cross-sectional view of a housing, a back cover, and a brush card according to a modification of a preferred embodiment of the present invention.

FIG. 14 is a partial longitudinal cross-sectional view of a housing, a back cover, and a brush card according to another modification of a preferred embodiment of the present invention.

### DETAILED DESCRIPTION OF THE PREFERRED EMBODIMENTS

Hereinafter, exemplary preferred embodiments of the present invention will be described. In addition, in the present invention, a direction parallel to a central axis of a motor is referred to as an “axial direction”, a direction orthogonal to the central axis of the motor is referred to as a “radial direction”, and a direction along an arc around the central axis of the motor as the center is referred to as a “circumferential direction”. In addition, in the present invention, the axial direction is referred to as a front-back direction. In addition, in the present invention, shapes and positional relationships of portions are described assuming that the axial direction is a forward and rearward direction and a housing side with respect to a back cover is a forward direction. In addition, a “parallel direction” in the present invention includes both a parallel direction and a substantially parallel direction. In addition, an “orthogonal direction” in the present invention includes both an orthogonal direction and a substantially orthogonal direction.

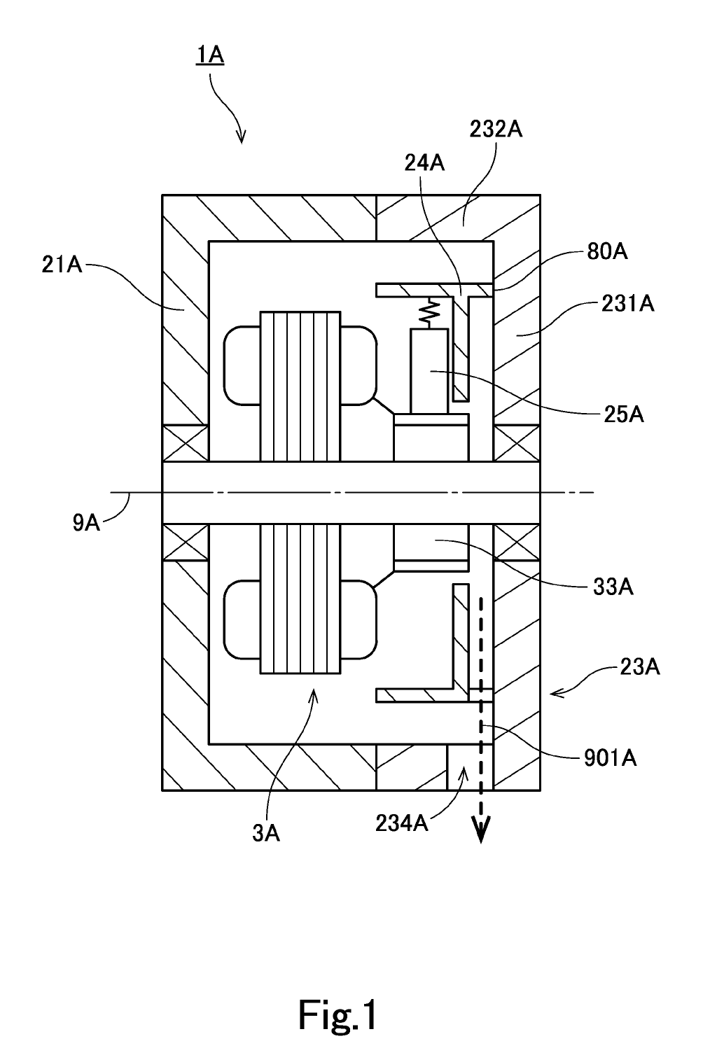

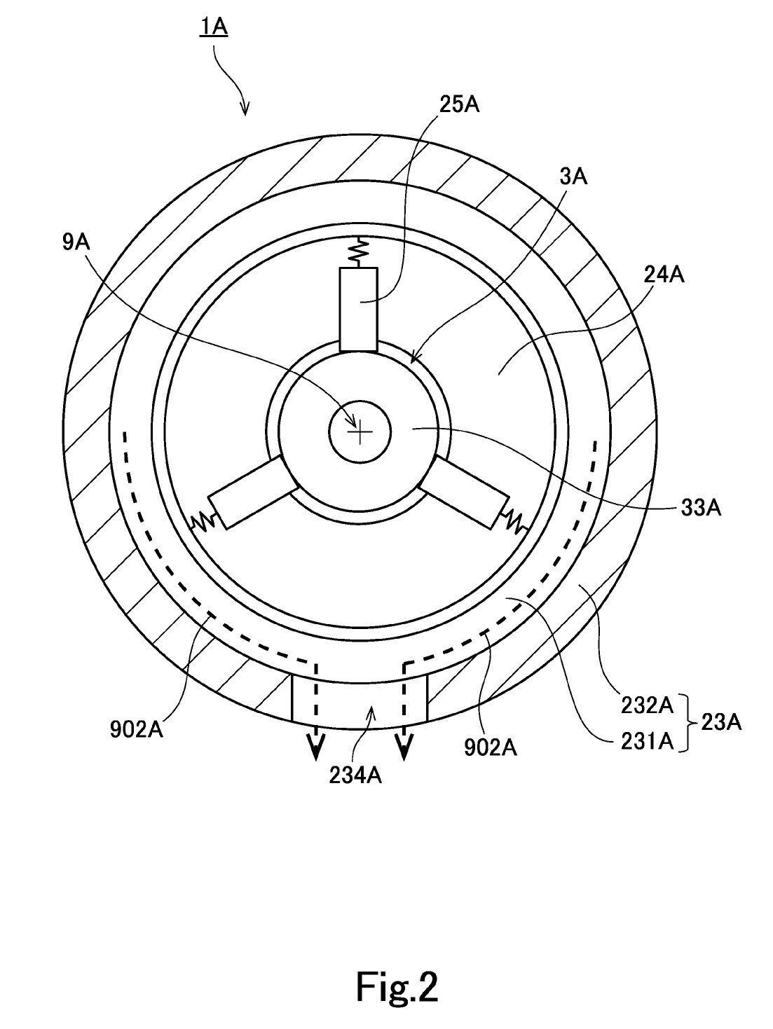

FIG. 1 is a longitudinal cross-sectional view of a motor 1A according to a first preferred embodiment. FIG. 2 is a view of the inside of the motor 1A viewed from the front. As illustrated in FIGS. 1 and 2, the motor 1A includes a rotating portion 3A, a housing 21A, a back cover 23A, a brush card 24A, and a brush 25A. The rotating portion 3A is supported to be rotatably centered on a central axis 9A which extends horizontally or substantially horizontally from the front to the rear. In addition, the rotating portion 3A includes a commutator 33A.

The housing 21A preferably is a cup-shaped or substantially cup-shaped member. At least a portion of the rotating portion 3A is accommodated in the housing 21A. The back cover 23A preferably is preferably a cup-shaped or substantially cup-shaped member. The back cover 23A is disposed on a rear side of the housing 21A. The commutator 33A, the brush card 24A, and the brush 25A are disposed in a casing constituted by the housing 21A and the back cover 23A. The brush card 24A extends in a direction orthogonal to the central axis 9A. Further, the brush 25A is disposed on a front side of the brush card 24A. The brush 25A is in contact with the commutator 33A.

The back cover 23A preferably includes a first rear wall portion 231A, a first circumferential wall portion 232A, and a through-hole 234A. The first rear wall portion 231A extends in the direction orthogonal to the central axis 9A in a rear side of the brush card 24A. The first circumferential wall portion 232A extends forward from an outer circumferential portion of the first rear wall portion 231A in a cylindrical or substantially cylindrical shape. The through-hole 234A penetrates in an up-and-down direction through the first circumferential wall portion 232A in the vicinity of a lower end portion of the first circumferential wall portion 232A. In addition

[symbol]

Further, as shown in FIG. 1, the back cover 23A and the brush card 24A are preferably in contact with each other at an annular or substantially annular contact portion 80A which is positioned radially inward of an inner circumferential surface of the first circumferential wall portion 232A. That is, the back cover 23A or the brush card 24A includes the contact portion 80A of the annular or substantially annular shape. A gap is provided between the inner circumferential surface of the first circumferential wall portion 232A and the contact portion 80A. Further, the contact portion 80A is disconnected at a position overlapped with the through-hole 234A in the radial direction.

In the motor 1A, if liquid droplets infiltrate radially inward of the contact portion 80A, the infiltrated droplets flow along an inner surface of the back cover 23A as indicated by the broken line arrow 901A in FIG. 1. And then, the droplets are discharged to the outside of the back cover 23A through the through-hole 234A. Further, if liquid droplets infiltrate between the first circumferential wall portion 232A and the contact portion 80A, the infiltrated droplets preferably flow along the inner surface of the back cover 23A as indicated by broken line arrows 902A in FIG. 2. And then, the droplets are preferably discharged to the outside of the back cover 23A through the through-hole 234A. Accordingly, the motor 1 is capable of efficiently discharging the droplets from the inside of the back cover 23A. As a result, the motor 1 is capable of significantly reducing or preventing the droplets from adhering to the brush 25A.

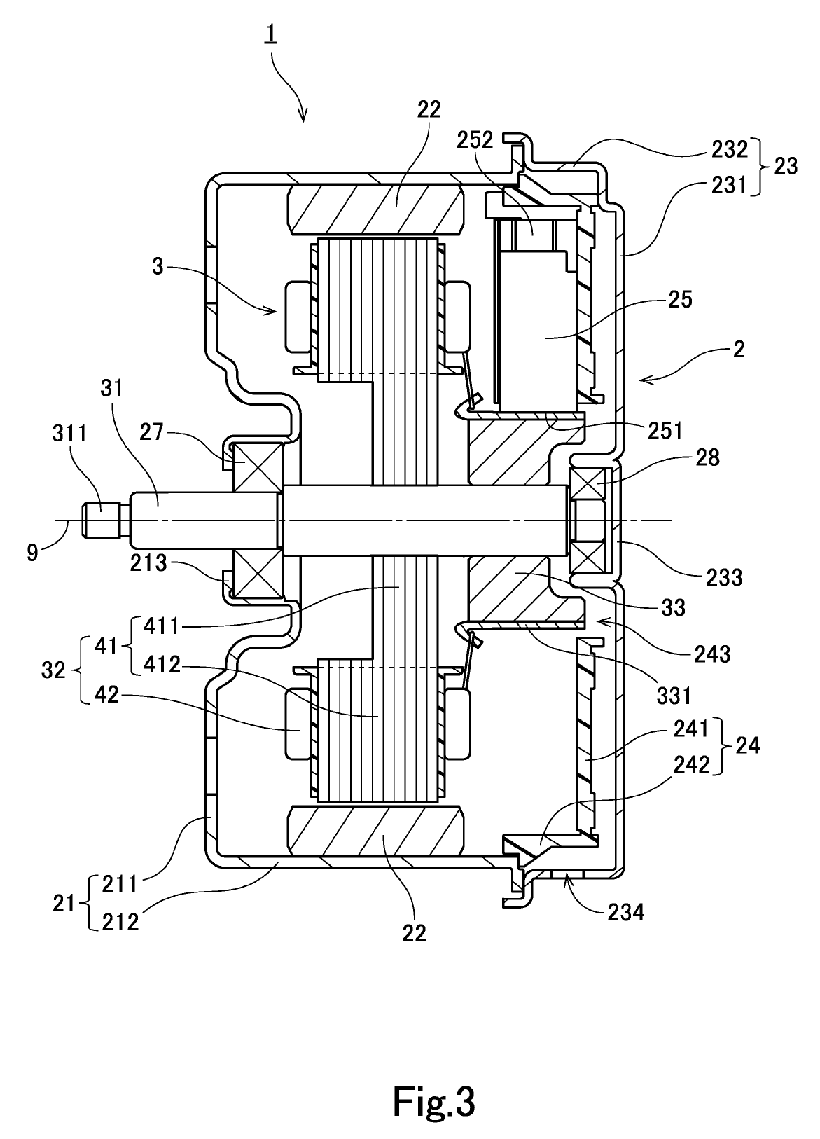

Subsequently, a second preferred embodiment of the present invention will be described. FIG. 3 is a longitudinal cross-sectional view of a motor 1 according to a second preferred embodiment. The motor of this preferred embodiment is preferably mounted, for example, in a vehicle and is used as a driving source of an engine cooling fan. As illustrated in FIG. 3, the motor 1 has a stationary portion 2 and a rotating portion 3. The stationary portion 2 is fixed to a frame body of an apparatus which is a driving object. The rotating portion 3 is supported to be rotatable with respect to the stationary portion 2.

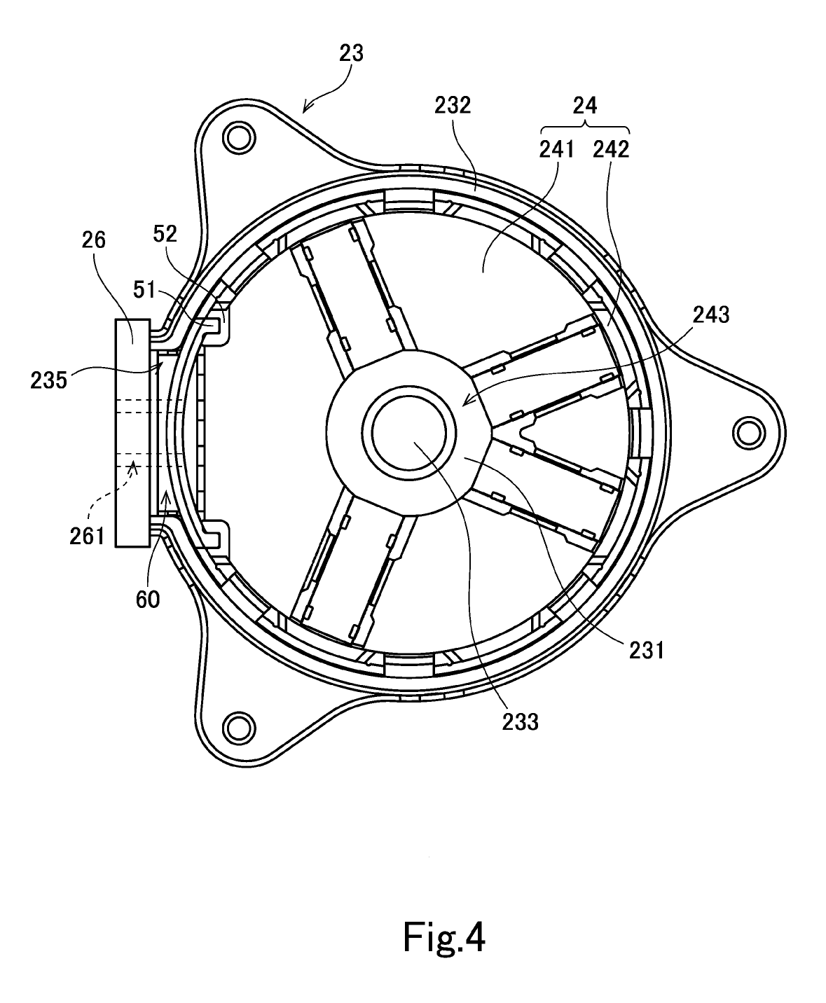

The stationary portion 2 of this preferred embodiment preferably includes a housing 21, a plurality of magnets 22, a back cover 23, a brush card 24, a plurality of brushes 25, a connector member 26, a front bearing portion 27, and a rear bearing portion 28. FIG. 4 is a view of the back cover 23, the brush card 24, and the connector member 26 viewed from the front side. The following description will be provided appropriately with reference to FIG. 4 together with FIG. 3.

The housing 21 is preferably a cup-shaped or substantially cup-shaped member which is opened toward the rear side. At least a portion of the rotating portion 3 is accommodated in the housing 21. The housing 21 is preferably made of, for example, a metal such as a galvanized steel sheet. However, another material such as, for example, a resin may also be used as the material of the housing 21.

As shown in FIG. 3, the housing 21 preferably includes a front wall portion 211 and a front circumferential wall portion 212. The front wall portion 211 extends in a disk shape or substantially in a disk shape in a direction orthogonal to a central axis 9 in front of an armature 32, which will be described later. A front bearing holding portion 213 which holds the front bearing portion 27 is provided at the center of the front wall portion 211. The front circumferential wall portion 212 extends rearward from an outer peripheral portion of the front wall portion 211 in a cylindrical or substantially cylindrical shape.

The plurality of magnets 22 is fixed to an inner circumferential surface of the front circumferential wall portion 212. The radially inner surfaces of the plurality of magnets 22 correspond to magnetic pole surfaces which radially oppose the armature 32 which will be described later. The plurality of magnets 22 are preferably arranged such that the magnetic pole surface of N pole and the magnetic pole surface of S pole are alternately arranged. The plurality of magnets 22 are preferably arranged at equal or substantially equal intervals in the circumferential direction. In addition, instead of the plurality of magnets 22, a single annular magnet in which the N poles and the S poles are alternately magnetized in the circumferential direction may also be used.

The back cover 23 is preferably a cup-shaped or substantially cup-shaped member which is opened forward. The back cover 23 is disposed rearward of the housing 21. The back cover 23 is preferably made of, for example, a metal such as a galvanized steel sheet. However, another material such as a resin may also be used as the material of the back cover 23. The plurality of magnets 22, the brush card 24, the plurality of brushes 25, the armature 32 (which will be described later), and a commutator 33 (which will be described later) are all preferably accommodated in a casing defined by the housing 21 and the back cover 23.

As shown in FIGS. 3 and 4, the back cover 23 includes a first rear wall portion 231 and a first circumferential wall portion 232. The first rear wall portion 231 extends, in the rear side of the brush card 24, in a disk shape or substantially in a disk shape in a direction orthogonal to the central axis 9. A rear bearing holding portion 233 which holds the rear bearing portion 28 is provided at the center of the first rear wall portion 231. The first circumferential wall portion 232 extends forward from an outer peripheral portion of the first rear wall portion 231 in a cylindrical or substantially cylindrical shape.

The first circumferential wall portion 232 preferably includes a through-hole 234 and a cut-out 235. As shown in FIG. 3, the through-hole 234 penetrates up-and-down through the first circumferential wall portion 232 in the vicinity of a lower end of the first circumferential wall portion 232. Further, as shown in FIG. 4, the cut-out 235 radially penetrates through the first circumferential wall portion 232 in the upper side of the through-hole 234. In this preferred embodiment, the cut-out 235 is disposed at a position having the same or substantially the same height as that of the central axis 9, that is, at a position separated from the through-hole 234 by about 90° with respect to the central axis 9.

The brush card 24 is disposed forward of the first rear wall portion 231 and radially inward of the first circumferential wall portion 232. A resin which is an electrical insulator is preferably used as the material of the brush card 24, for example. As shown in FIGS. 3 and 4, the brush card 24 preferably includes a second rear wall portion 241 and a second circumferential wall portion 242. The second rear wall portion 241 extends, in the front side of the first rear wall portion 231, in a disk shape or substantially in a disk shape in the direction orthogonal to the central axis 9. The center of the second rear wall portion 241 preferably includes a circular hole 243 in which the rear bearing holding portion 233 or the commutator 33 (which will be described later) is provided at the center of the second rear wall portion 241. The second circumferential wall portion 242 extends forward from an outer peripheral portion of the second rear wall portion 241 in a cylindrical or substantially cylindrical shape.

The plurality of brushes 25 are held by the brush card 24. Each brush 25 is an electrical conductor which is in contact with the commutator 33, which will be described later. As shown in FIG. 3, in this preferred embodiment, the plurality of brushes 25 are disposed forward of the second rear wall portion 241 and radially inward the second circumferential wall portion 242. Accordingly, liquid droplets are preferably prevented from adhering to the brush 25. Each brush 25 includes a contact surface 251 which is in contact with a segment 331 of the commutator 33. Further, each brush 25 is preferably biased radially inward by a spring 252 interposed between the brush 25 and the second circumferential wall portion 242. Accordingly, the contact surface 251 is pressed against the segment 331. As a result, the brush 25 and the segment 331 are electrically connected to each other.

The connector member 26 is a member which supports a lead wire that connects the brush 25 and an external power source. As a material of the connector member 26, for example, a resin that is an insulator is used. The connector member 26 is disposed in the radially outer side of the brush card 24. Further, the connector member 26 is preferably fixed to the back cover 23 in the state of being fitted to the cut-out 235 of the back cover 23.

Further, the connector member 26 includes one or a plurality of communication holes 261. The communication hole 261 penetrates through the connector member 26 in the radial direction. The lead wire that extends from the external power source is connected to the brush 25 through the communication hole 261 of the connector member 26.

The front bearing portion 27 and the rear bearing portion 28 are mechanisms that rotatably support a shaft 31 of the rotating portion 3. Ball bearings which rotate outer races and inner races relatively with respect to each other via spheres are preferably used as the front bearing portion 27 and the rear bearing portion 28 of this preferred embodiment, for example. The outer race of the front bearing portion 27 is fixed to the front bearing holding portion 213 of the housing 21. The outer race of the rear bearing portion 28 is fixed to the rear bearing holding portion 233 of the back cover 23. Further, each inner race of the front bearing portion 27 and the rear bearing portion 28 is fixed to the shaft 31. Here, instead of the ball bearing, other types of bearings such as, for example, a sliding bearing or a fluid bearing may be used if so desired.

The rotating portion 3 of this preferred embodiment includes the shaft 31, the armature 32, and the commutator 33.

The shaft 31 is disposed along the central axis 9 that horizontally or substantially horizontally extends in the front-rear direction. The shaft 31 is supported by the front bearing portion 27 and the rear bearing portion 28, and rotates centered on the central axis 9. Further, the shaft 31 preferably includes a head portion 311 which protrudes more forward than the front wall portion 211 of the housing 21. A component that is a driving object (for example, an impeller) is mounted to the head portion 311.

The armature 32 is disposed radially inward of the plurality of magnets 22. The armature 32 preferably includes an armature core 41 and a coil 42. The armature core 41 is preferably made of, for example, laminated steel sheets. The armature core 41 includes an annular core back 411 and a plurality of teeth 412 which protrude radially outward from the core back 411. The shaft 31 is preferably press-fitted, for example, into the radial inside of the core back 411. The plurality of teeth 412 are arranged at uniform intervals in the circumferential direction. The coil 42 is defined by a conducting wire wound around the teeth 412.

The commutator 33 is fixed to the shaft 31 in the rear side of the armature 32. A plurality of conductive segments 331 are preferably provided at uniform intervals in the circumferential direction on an outer circumferential surface of the commutator 33. Further, the conducting wire led out from the coil 42 is electrically connected to each segment 331.

An electrical drive current supplied from the external power source flows to the coil 42 through the lead wire, the brush 25 and the segment 331. When the drive current is supplied to the coil 42, magnetic flux is generated in the teeth 412. Further, a circumferential torque is generated by magnetic attraction or magnetic repulsion between the teeth 412 and the magnets 22. As a result, the rotating portion 3 rotates centered on the central axis 9 with respect to the stationary portion 2. Further, when the commutator 33 rotates, the contact surfaces 251 of the respective brushes 25 sequentially come into contact with the plurality of segments 331. Thus, the driving current is sequentially supplied to the plurality of coils 42. Consequently, the rotating portion 3 continuously rotates.

Subsequently, a drainage structure of the motor 1 according to this preferred embodiment will be described.

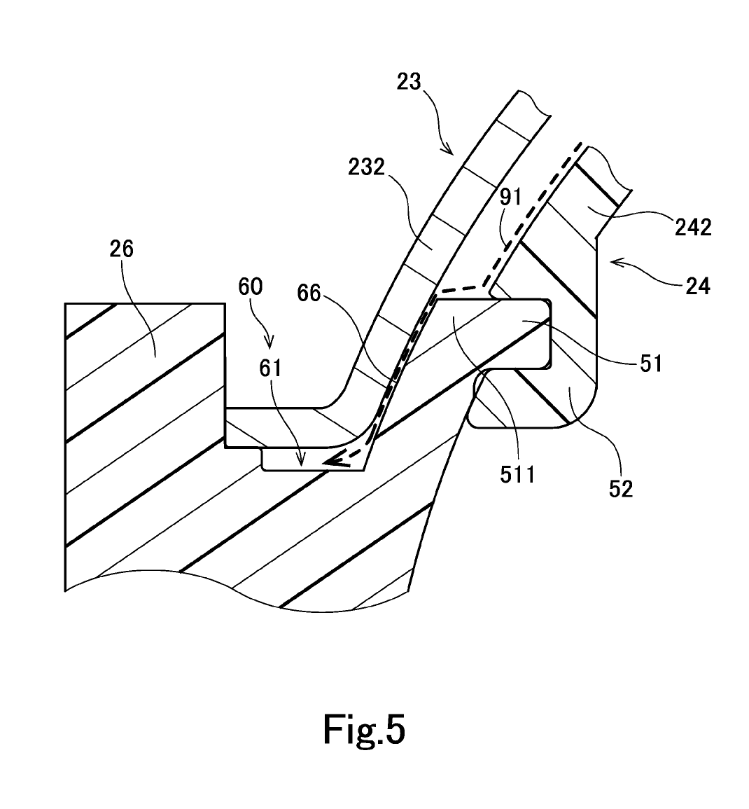

FIG. 5 is a partial longitudinal cross-sectional view of the back cover 23, the brush card 24, and the connector member 26. As shown in FIGS. 4 and 5, the connector member 26 preferably includes a pair of protruding portions 51. The pair of protruding portions 51 protrude radially inward from both end portions of the connector member 26 in the circumferential direction. On the other hand, the second circumferential wall portion 242 of the brush card 24 preferably includes a pair of recessed portions 52. The pair of protruding portions 51 are respectively fitted into the pair of recessed portions 52.

As shown in FIG. 5, in this preferred embodiment, at least one of both end surfaces in the circumferential direction of the protruding portion 51 and the end surface in the radially inner side of the protruding portion 51 are in contact with the surface of the recessed portion 52. That is, the protruding portion 51 and the recessed portion 52 come into contact with each other at a plurality of surfaces which are continuous. Accordingly, infiltration of liquid droplets into the radial inside from the boundary portion between the connector member 26 and the brush card 24 is significantly reduced or prevented.

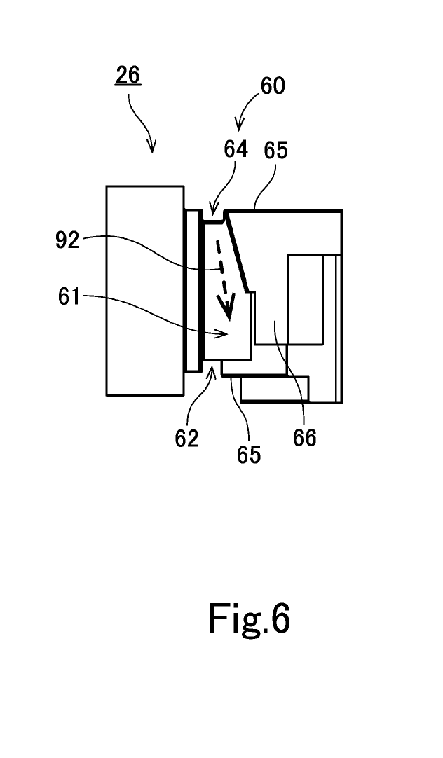

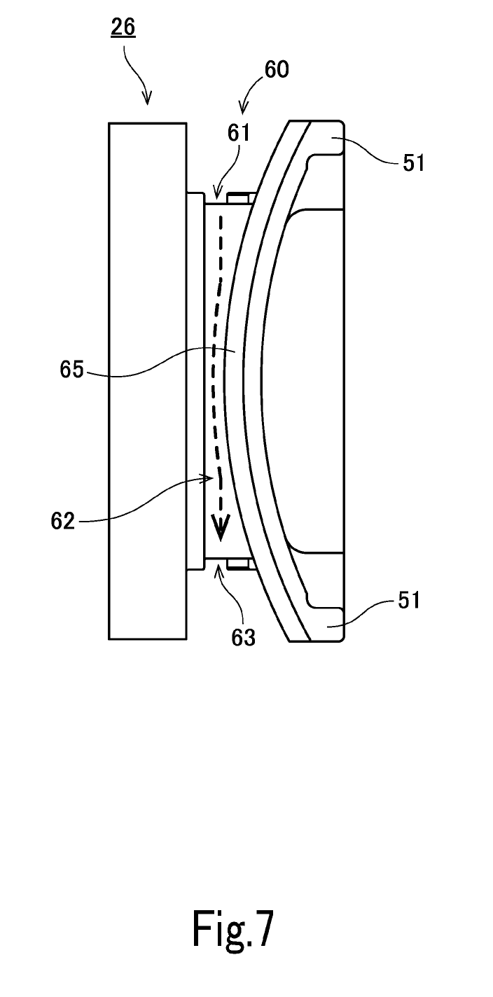

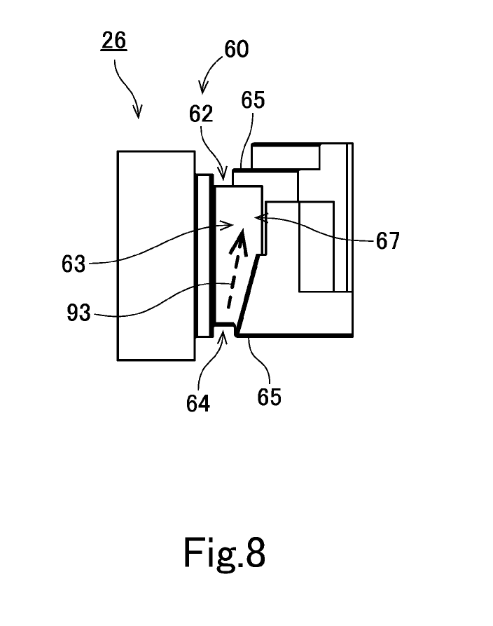

FIG. 6 is a top view of the connector member 26. FIG. 7 is a view of the connector member 26 viewed from the front. FIG. 8 is a bottom view of the connector member 26. As shown in FIGS. 6 to 8, a flow path groove 60 is preferably provided on the outer surface of the connector member 26. When liquid droplets such as, for example, water droplets adhere to the outer surface of the connector member 26, the liquid droplets are collected in the flow path groove 60 due to gravity and surface tension.

The flow path groove 60 preferably includes an upper axial groove 61, a front circumferential groove 62, a lower axial groove 63, and a back circumferential groove 64. As shown in FIGS. 6 and 7, the upper axial groove 61 axially extends on an upper surface of the connector member 26. As shown in FIGS. 6 to 8, the front circumferential groove 62 circumferentially and vertically extends on the surface of the front side of the connector member 26. As shown in FIGS. 7 and 8, the lower axial groove 63 axially extends on a lower surface of the connector member 26. Further, as shown in FIGS. 6 and 8, the rear circumferential groove 64 circumferentially and vertically extends on the surface of the rear side of the connector member 26.

Liquid droplets collected in the flow path groove 60 flow toward the lower axial groove 63 due to gravity. Particularly, in this preferred embodiment, the upper axial groove 61, the front circumferential groove 62, the lower axial groove 63, and the back circumferential groove 64 are preferably connected in an annular shape. Therefore, the liquid droplets collected in the upper axial groove 61 reach the lower axial groove 63 even when flowing to any of the front circumferential groove 62 and the rear circumferential groove 64. Accordingly, the liquid droplets are efficiently collected in the lower axial groove 63.

Further, as shown in FIG. 5, in this preferred embodiment, a base end portion 511 of the protruding portion 51 of the connector member 26 is positioned in the radially outer side than the outer circumferential surface of the second circumferential wall portion 242 of the brush card 24. Accordingly, liquid droplets are prevented from staying in the boundary between the second circumferential wall portion 242 and the protruding portion 51. Liquid droplets adhering to the outer circumferential surface of the second circumferential wall portion 242 flow toward the upper axial groove 61 along the base end portion 511 of the protruding portion 51, as indicated by a broken line arrow 91 in FIG. 5.

Further, as shown in FIGS. 6 to 8, the connector member 26 of this preferred embodiment preferably includes an inner disk surface 65 in the radially inner side of the flow path groove 60. The inner disk surface 65 extends radially inward from the edge of the radially inner side of the flow path groove 60. Further, the inner disk surface 65 is in contact with the housing 21 or the back cover 23. Accordingly, infiltration of liquid droplets into the radially inner side from the flow path groove 60 is significantly reduced or prevented.

In addition, as shown in FIGS. 5 and 6, the connector member 26 of this preferred embodiment preferably includes a tapered surface 66 in the radially inner side of the upper axial groove 61. The tapered surface 66 is inclined so that the height thereof increases as it heads radially inward form the edge of the radially inner side of the upper axial groove 61. Therefore, even if liquid droplets collected in the upper axial groove 61 overflow from the upper axial groove 61, the liquid droplets return to the upper axial groove 61 due to the tapered surface 66. Accordingly, infiltration of liquid droplets into the radially inner side is preferably further significantly reduced or prevented.

As shown in FIG. 5, the tapered surface 66 is disposed radially inward than the first circumferential wall portion 232 of the back cover 23. Therefore, liquid droplets that flow into the base end portion 511 of the protruding portion 51 from the outer circumferential surface of the second circumferential wall portion 242 are collected in the upper axial groove 61 through a space between the first circumferential wall portion 232 and the tapered surface 66 as indicated by the broken line arrow 91 in FIG. 5.

Further, as shown in FIG. 6, the upper axial groove 61 in this preferred embodiment preferably includes a portion of which the width in the radial direction is enlarged as it heads forward. The flow resistance of the portion increases as it heads toward the rear. Therefore, the liquid droplets collected in the upper axial groove 61 are preferably guided forward as indicated by a broken line arrow 92 in FIG. 6. Further, liquid droplets that flow forward from the upper axial groove 61 flow to the lower axial groove 63 through the front circumferential groove 62.

Further, as shown in FIG. 8, the connector member 26 of this preferred embodiment includes a guide groove 67 in the radially inner side of the lower axial groove 63. The guide groove 67 preferably extends radially inward from the lower axial groove 63. Further, the lower axial groove 63 of this preferred embodiment includes a portion of which the width in the radial direction increases as it heads toward the guide groove 67. The flow resistance of the portion decreases as it heads toward the guide groove 67. Therefore, the liquid droplets collected in the lower axial groove 63 are preferably guided to the guide groove 67 side as indicated by a broken line arrow 93 in FIG. 8.

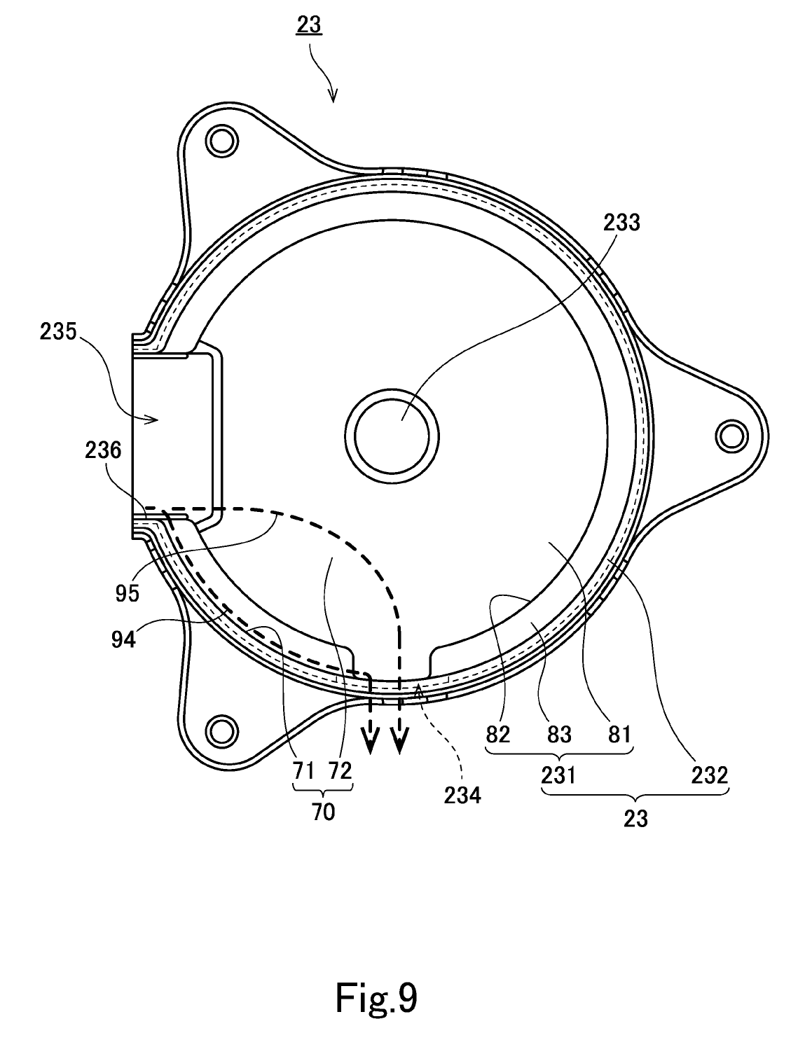

FIG. 9 is a view of the back cover 23 viewed from the front. The cut-out 235 of the back cover 23 preferably includes an opposing surface 236 positioned in the lower side of the connector member 26. The opposing surface 236 vertically opposes the guide groove 67 of the connector member 26. Further, the inner surface of the back cover 23 includes a flow path surface 70 which continues from the opposing surface 236 to the through-hole 234. Liquid droplets collected in the flow path groove 60 of the connector member 26 flow to the opposing surface 236 from the guide groove 67. Further, the liquid droplets flow down the flow path surface 70 to the through-hole 234 as indicated by broken line arrows 94 and 95 in FIG. 9, and are discharged to the outside of the back cover 23.

In this way, in the motor 1 of this preferred embodiment of the present invention, liquid droplets adhering to the connector member 26 flow down the flow path groove 60 and the flow path surface 70 and are discharged to the outside of the back cover 23 through the through-hole 234. Therefore, in the motor 1, liquid droplets are significantly reduced or prevented adhering to the brush without the need for an 0-ring, a gasket, etc. As a result, the number of components of the motor 1 is significantly reduced and the manufacturing cost is also significantly reduced.

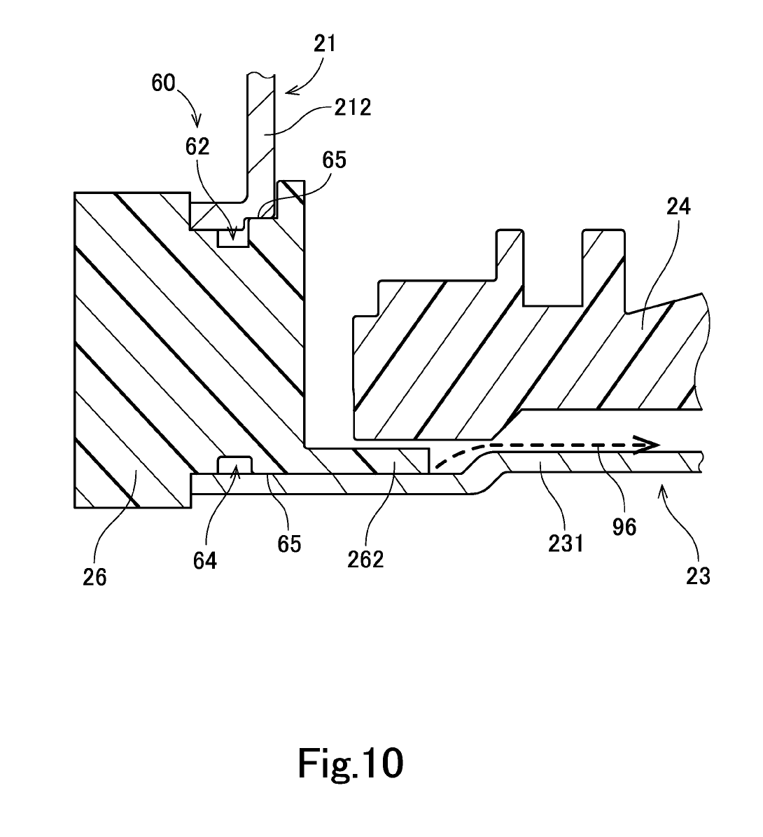

FIG. 10 is a partial transverse cross-sectional view of the housing 21, the back cover 23, the brush card 24, and the connector member 26. As shown in FIG. 10, the connector member 26 of this preferred embodiment preferably includes a plate-shaped protruding portion 262 in the radially inner side of the rear circumferential groove 64. The plate-shaped protruding portion 262 extends radially inward along the surface of in the front side of the first rear wall portion 231. The surface in the rear side of the plate-shaped protruding portion 262 is in contact with the surface in the front side of the first rear wall portion 231. In addition, the end edge portion in the radially inner side of the plate-shaped protruding portion 262 is preferably positioned in the radially inner side than the end edge portion in the radially outer side of the brush card 24.

Therefore, even if liquid droplets infiltrate into the radial inside from a space between the first rear wall portion 231 and the plate-shaped protruding portion 262, the liquid droplets flow along the surface in the front side of the first rear wall portion 231 as indicated by a broken line arrow 96 in FIG. 10. Accordingly, liquid droplets are preferably prevented from infiltrating into the front side of the brush card 24. As a result, adhesion of the liquid droplets to the brush 25 is preferably further significantly reduced or prevented.

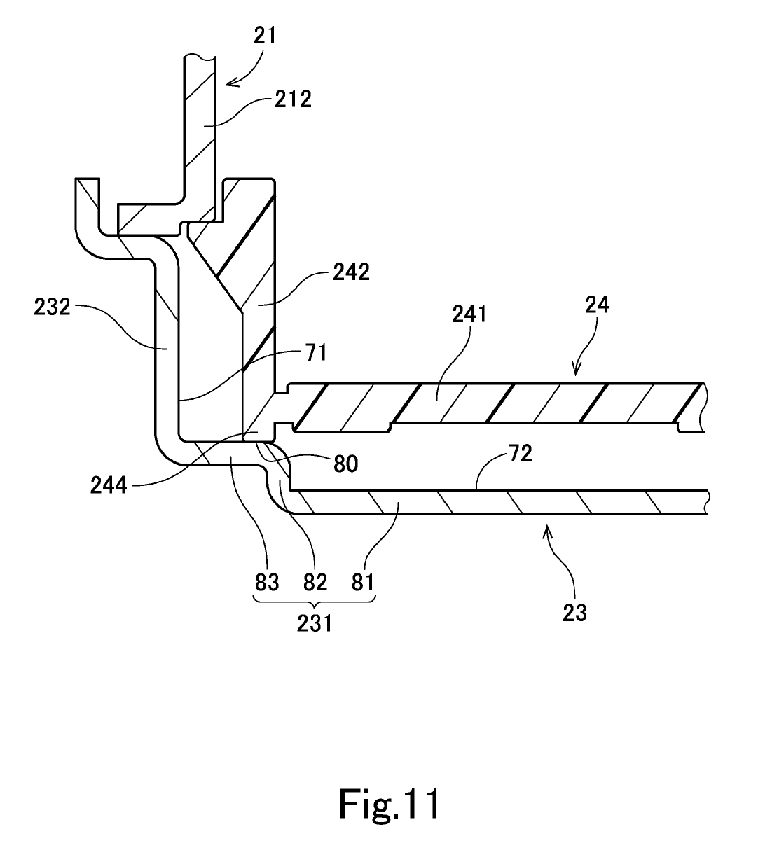

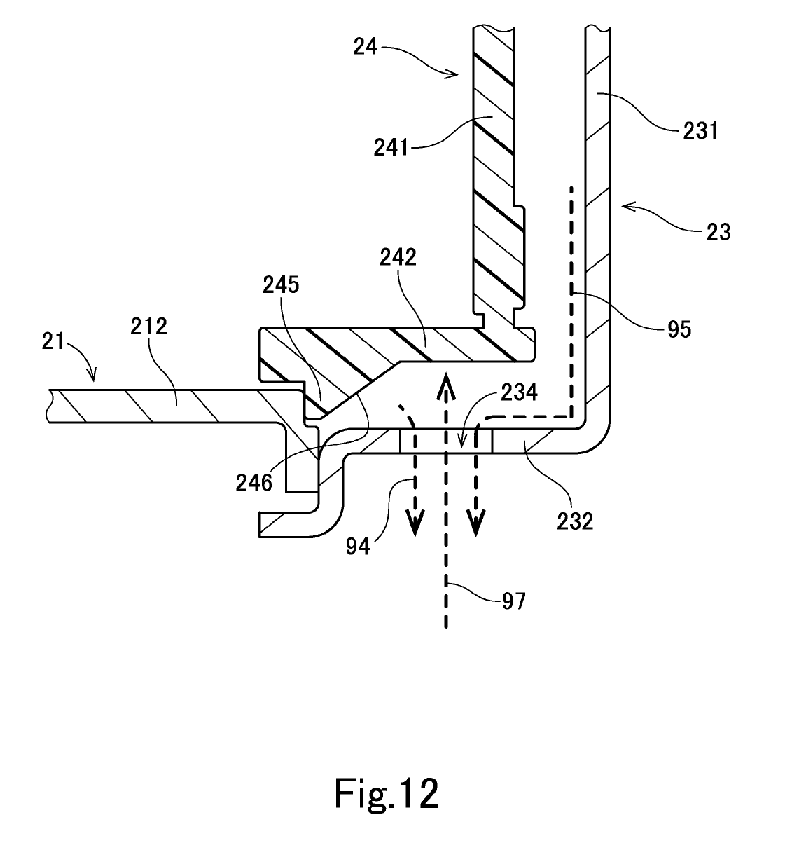

FIGS. 11 and 12 are partial cross-sectional views of the housing 21, the back cover 23, and the brush card 24. FIG. 12 illustrates a longitudinal cross-section including the through-hole 234. FIG. 11 illustrates a cross-section at a different position in the circumferential direction from that of FIG. 12. As shown in FIG. 11, the first rear wall portion 231 of the back cover 23 preferably includes an inner rear wall portion 81, an inner circumferential wall portion 82, and an outer rear wall portion 83. The inner rear wall portion 81 extends in the direction orthogonal to the central axis 9 in the rear side having a gap from the second rear wall portion 241 of the brush card 24. The inner circumferential wall portion 82 extends in a cylindrical or substantially cylindrical shape forward from the outer circumferential portion of the inner rear wall portion 81. The outer rear wall portion 83 extends radially outward from the front end portion of the inner circumferential wall portion 82. The end edge portion in the radially outer side of the outer rear wall portion 83 is connected to the rear end portion of the first circumferential wall portion 232.

Further, the brush card 24 preferably includes a leg portion 244 of an annular or substantially annular shape. The leg portion 244 extends rearward from the outer circumferential portion of the second rear wall portion 241. Further, in this preferred embodiment of the present invention, the outer rear wall portion 83 of the back cover 23 and the leg portion 244 of the brush card 24 preferably come into contact with each other at an annular or substantially annular contact portion 80. That is, the back cover 23 or the brush card 24 includes the substantially annular contact portion 80. The contact portion 80 is positioned in the radially inner side including a gap from the inner circumferential surface of the first circumferential wall portion 232.

As shown in FIGS. 9 to 11, the flow path surface 70 of the back cover 23 preferably includes a first flow path surface 71 and a second flow path surface 72. The first flow path surface 71 is positioned farther radially outward than the contact portion 80. Further, the first flow path surface 71 belongs to the inner circumferential surface of the first circumferential wall portion 232 and the surface in the front side of the outer rear wall portion 83. The second flow path surface 72 is positioned radially inward than the contact portion 80. The second flow path surface 72 corresponds to the surface in the front side of the inner rear wall portion 81 and the inner circumferential surface of the inner circumferential wall portion 82.

Liquid droplets which have infiltrated between the first circumferential wall portion 232 and the contact portion 80 flow down the first flow path surface 71 to the through-hole 234 as indicated by the broken line arrow 94 in FIGS. 9 and 12. Further, liquid droplets which have infiltrated into the radially inner side than the contact portion 80 flow down the second flow path surface 72 to the through-hole 234 as indicated by the broken line arrow 95 in FIGS. 9 and 12. In this way, the motor 1 of this preferred embodiment preferably discharges liquid droplets infiltrated into the back cover 23 through two paths. That is, in the motor 1, liquid droplets that are present in any of the radially outer side of the radially inner side of the contact portion 80 can also be discharged to the outside of the back cover 23 through the through-hole 234. Therefore, in the motor 1, the liquid droplets are efficiently discharged from the inside of the back cover 23. As a result, in the motor 1, the liquid droplets are significantly reduced or prevented from adhering to the brush 25.

Further, as shown in FIG. 9, the inner circumferential wall portion 82 and the outer rear wall portion 83 are preferably not provided at a position that overlaps with the through-hole 234 in the radial direction. Therefore, as shown in FIG. 12, the contact portion 80 is disconnected at the position that overlaps with the through-hole 234 in the radial direction. Therefore, in the motor 1, liquid droplets that flow down the second flow path surface 72 flow to the through-hole 234 through the portion where the contact portion 80 is disconnected. Particularly, in this preferred embodiment, as in FIG. 9, the surface in the front side of the inner rear wall portion 81 is preferably a flat surface without stepped portions. Therefore, in the motor 1, liquid droplets more efficiently flow along the second flow path surface 72 to the through-hole 234.

Liquid droplets discharged from the through-hole 234 are not only the liquid droplets that are guided to the back cover 23 through the flow path groove 60 of the connector member 26. For example, liquid droplets which have infiltrated through a through-hole provided in the housing 21 or liquid droplets which have infiltrated from the boundary portion between the housing 21 and the back cover 23 also flow down the first flow path surface 71 and the second flow path surface 72 and are discharged to the outside of the back cover 23 through the through-hole 234.

Further, as shown in FIG. 11, in this preferred embodiment of the present invention, the inner circumferential surface of the first circumferential wall portion 232 of the back cover 23 and the outer circumferential surface of the second circumferential wall portion 242 of the brush card 24 oppose each other via a gap in the radial direction. Accordingly, movement of liquid droplets from the first flow path surface 71 toward the brush 25 is preferably further significantly reduced or prevented.

Further, as shown in FIG. 11, in this preferred embodiment, the surface in the front side of the first rear wall portion 231 of the back cover 23 and the rear surface in the rear side of the second rear wall portion 241 of the brush card 24 oppose each other via a gap in the axial direction. Accordingly, movement of liquid droplets from the second flow path surface 72 to the brush 25 is preferably further significantly reduced or prevented. In this preferred embodiment, the gap in the axial direction is defined by allowing the outer rear wall portion 83 of the back cover 23 and the leg portion 244 of the brush card 24 to come into contact with each other. However, one of the outer rear wall portion 83 and the leg portion 244 may also be omitted if so desired.

Further, the motor 1 of this preferred embodiment brings cooling air into the housing 21 and the back cover 23 when driving. Specifically, as indicated by a broken line arrow 97 in FIG. 12, gas flows into the back cover 23 through the through-hole 234. The inflow of the gas occurs due to the rotation of the rotating portion 3. The brush 25 and the coil 42 are cooled by the gas.

Here, in this preferred embodiment of the present invention, the front end portion of the second circumferential wall portion 242 of the brush card 24 is positioned forward than the through-hole 234. Therefore, the gas indicated by the arrow 97 is preferably prevented from being directly blown to the radial inside of the second circumferential wall portion 242. Therefore, even though liquid droplets are mixed with the gas indicated by the arrow 97, infiltration of the liquid droplets farther to the radially inner side than the second circumferential wall portion 242 is significantly reduced or prevented.

In addition, as illustrated in FIG. 12, the brush card 24 of this preferred embodiment preferably includes an overhang portion 245. The overhang portion 245 protrudes radially outward from the outer circumferential surface of the second circumferential wall portion 242. In addition, the overhang portion 245 is positioned more towards a front side than the rear end portion of the through-hole 234. Accordingly, inflow of the gas indicated by the arrow 97 toward the front side is preferably further significantly reduced or prevented. Particularly, in this preferred embodiment, the radially outer surface of the overhang portion 245 is an inclined surface 246 which is displaced forward as it heads radially outward. In addition, the surface in the front side of the overhang portion 245 comes into contact with the rear end portion of the housing 21. Accordingly, inflow of the gas to the front is further significantly reduced or prevented.

While exemplary preferred embodiments of the present invention have been described above, the present invention is not limited to the preferred embodiments described above.

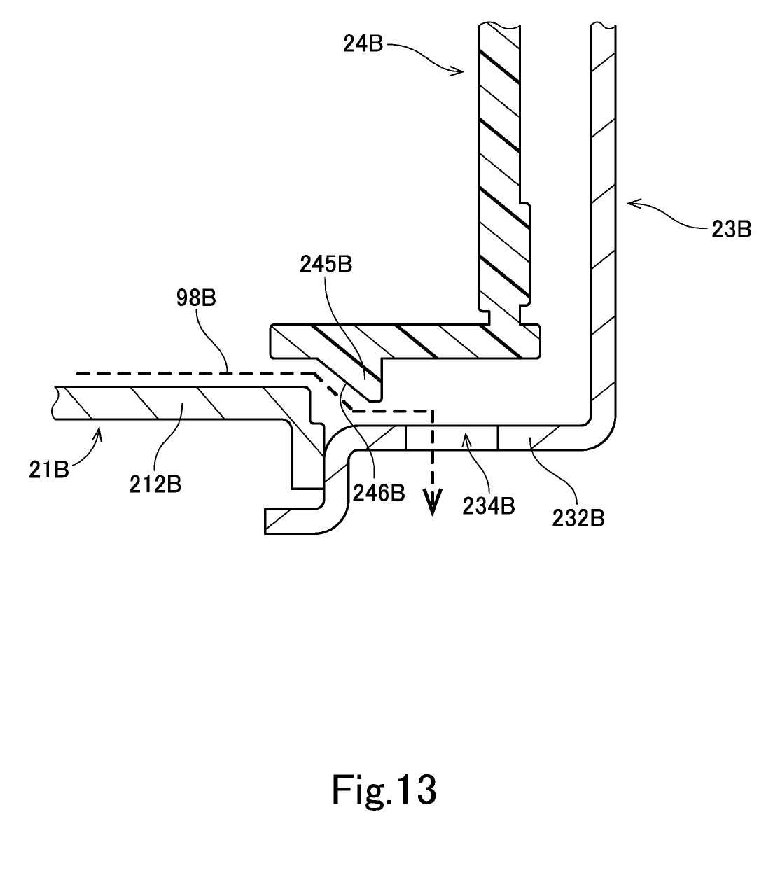

FIG. 13 is a partial longitudinal cross-sectional view of a housing 21B, a back cover 23B, and a brush card 24B according to a modified preferred embodiment of the present invention. In the preferred embodiment of FIG. 13, a gap in the radial direction is preferably interposed between an overhang portion 245B and an inner circumferential surface of a first circumferential wall portion 232B or the inner circumferential surface of a front circumferential wall portion 212B. In this manner, as indicated by the broken line arrow 98B in FIG. 13, liquid droplets which have infiltrated into the housing 21B flow down the inner circumferential surface of the front circumferential wall portion 212B and the inner circumferential wall surface of the first circumferential wall portion 232B and are discharged to the outside of the back cover 23B through a through-hole 234B.

Particularly, in the preferred embodiment of FIG. 13, the surface in the front side of the overhang portion 245B is preferably an inclined surface 246B which is displaced rearward as it heads radially outwards. Therefore, in the structure of the preferred embodiment of FIG. 13 in the radially outer side of the overhang portion 245B, liquid droplets are guided toward the through-hole 234B more efficiently.

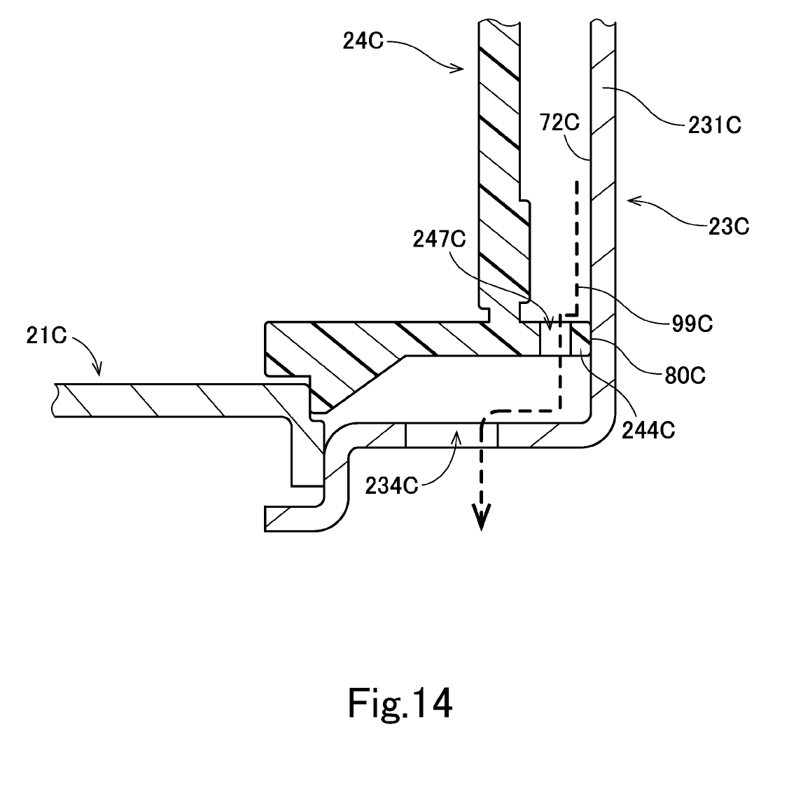

FIG. 14 is a partial longitudinal cross-sectional view of a housing 21C, a back cover 23C, and a brush card 24C according to another modified preferred embodiment. In the preferred embodiment of FIG. 14, a contact portion 80C between the back cover 23C and the brush card 24C is preferably not disconnected at a position that overlaps with a through-hole 234C in the radial direction. That is, even at the position that overlaps with the through-hole 234C in the radial direction, a first rear wall portion 231C of the back cover 23C and a leg portion 244C of the brush card 24C are in contact with each other.

However, in the preferred embodiment of FIG. 14, at a position that overlaps with the through-hole 234C in the radial direction, the leg portion 244C of the brush card 24C preferably includes a flow path hole 247C that penetrates farther from the radially inner side to the radially outer side than the contact portion 80C. Therefore, liquid droplets, as indicated by the arrow 99C in FIG. 14, liquid droplets which have infiltrated the housing 21C flow down a second flow path surface 72C toward the through-hole 234C through the flow path hole 247C. In addition, the leg portion 244C preferably also is provided with a cut-out instead of the flow path hole 247C.

The motors according to preferred embodiments of the present invention may be, for example, a motor configured to rotating an in-vehicle fan or may also be a motor used for other purposes. For example, the motors according to preferred embodiments of the present invention may also be used as a driving source of power steering of a vehicle. In addition, the motors according to various preferred embodiments of the present invention may also be mounted in home appliances, office automation equipment, medical equipment, and the like to generate various types of driving forces.

However, the preferred embodiments of the present invention are particularly useful to a motor used in an environment in which liquid droplets are likely to be present. Therefore, various preferred embodiments of the present invention are particularly useful to a motor mounted in a transportation machine such as a car, or a fan motor for cooling a server provided outdoors, a router, a communication base, a switch device, or the like.

The number of the through-holes provided in the back cover may be one as in the above-described preferred embodiments, or may also be two or more. In addition, the position of the connector member may not necessarily be the position that is separated from the through-hole by about 90° with respect to the central axis 9. In addition, detailed shapes of the members may also be different from the shapes illustrated in the drawings of the present application. In addition, the drainage structure of various preferred embodiments of the present invention may also be used in combination with a seal member such as an O-ring or a gasket.

In addition, the elements that appear in the above-described preferred embodiments and the modified examples may also be appropriately combined in a range in which there is no contradiction.

The above-described preferred embodiments and the modified examples may be used for a motor.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-10. (canceled)

11. A motor comprising:
a rotating portion supported to be rotatably centered on a central axis which extends horizontally or substantially horizontally in a front-rear direction, the rotating portion including a commutator;
a cup-shaped or substantially cup-shaped housing which accommodates at least a portion of the rotating portion;
a cup-shaped or substantially cup-shaped back cover which is disposed rearward of the housing and which, together with the housing, defines a casing;
a brush card which is disposed inside the casing and extends in a direction orthogonal or substantially orthogonal to the central axis; and
a brush which is disposed forward of the brush card and is in contact with the commutator; wherein the back cover includes:
a first rear wall portion which extends in the direction orthogonal or substantially orthogonal to the central axis on a rear side of the brush card;
a first circumferential wall portion of a cylindrical or substantially cylindrical shape, which extends forward from an outer peripheral portion of the first rear wall portion; and
a through-hole which vertically penetrates through the first circumferential wall portion in a vicinity of a lower end portion of the first circumferential wall portion;
the back cover or the brush card includes a contact portion of an annular or substantially annular shape at which the back cover and the brush card are in contact with each other in a radially inner side of an inner circumferential surface of the first circumferential wall portion via a gap; and
the contact portion is disconnected at a position which radially overlaps with the through-hole, or the brush card is penetrated radially outward from the radially inner side than the contact portion at the position which radially overlaps with the through-hole.

12. The motor according to claim 11, wherein
the brush card includes:
a second rear wall portion which is disposed forward of the first rear wall portion; and
a second circumferential wall portion of a cylindrical or substantially cylindrical shape, which extends forward from an outer peripheral portion of the second rear wall portion; and
the brush is disposed forward of the second rear wall portion and radially inward of the second circumferential wall portion.

13. The motor according to claim 12, wherein
the first rear wall portion includes:
an inner rear wall portion which is positioned rearward of the second rear wall portion via a gap;
an inner circumferential wall portion of a cylindrical or substantially cylindrical shape, which extends forward from an outer peripheral portion of the inner rear wall portion; and
an outer rear wall portion that extends radially outward from a front end portion of the inner circumferential wall portion; and
the outer rear wall portion and the brush card are in contact with each other at the contact portion.

14. The motor according to claim 13, wherein a front surface of the inner rear wall portion is a flat surface without a step.

15. The motor according to claim 12, wherein
the brush card further includes a leg portion which extends rearward from an outer circumferential portion of the second rear wall portion; and
the first rear wall portion and the leg portion are in contact with each other at the contact portion.

16. The motor according to claim 13, wherein
the brush card further includes a leg portion which extends rearward from an outer circumferential portion of the second rear wall portion; and
the first rear wall portion and the leg portion are in contact with each other in the contact portion.

17. The motor according to claim 14, wherein
the brush card further includes a leg portion which extends rearward from an outer circumferential portion of the second rear wall portion; and
the first rear wall portion and the leg portion are in contact with each other in the contact portion.

18. The motor according to claim 12, wherein a front end portion of the second circumferential wall portion is positioned farther forward than the through-hole.

19. The motor according to claim 13, wherein a front end portion of the second circumferential wall portion is positioned farther forward than the through-hole.

20. The motor according to claim 14, wherein a front end portion of the second circumferential wall portion is positioned farther forward than the through-hole.

21. The motor according to claim 15, wherein a front end portion of the second circumferential wall portion is positioned farther forward than the through-hole.

22. The motor according to claim 16, wherein a front end portion of the second circumferential wall portion is positioned farther forward than the through-hole.

23. The motor according to claim 17, wherein a front end portion of the second circumferential wall portion is positioned farther forward than the through-hole.

24. The motor according to claim 18, wherein
the brush card includes an overhang portion which protrudes radially outward from an outer circumferential surface of the second circumferential wall portion; and
the overhang portion is positioned farther forward than a rear end portion of the through-hole.

25. The motor according to claim 19, wherein
the brush card includes an overhang portion which protrudes radially outward from an outer circumferential surface of the second circumferential wall portion; and
the overhang portion is positioned farther forward than a rear end portion of the through-hole.

26. The motor according to claim 20, wherein
the brush card includes an overhang portion which protrudes radially outward from an outer circumferential surface of the second circumferential wall portion; and
the overhang portion is positioned farther forward than a rear end portion of the through-hole.

27. The motor according to claim 21, wherein
the brush card includes an overhang portion which protrudes radially outward from an outer circumferential surface of the second circumferential wall portion; and
the overhang portion is positioned farther forward than a rear end portion of the through-hole.

28. The motor according to claim 24, wherein a radial gap is interposed between the overhang portion and the inner circumferential surface of the first circumferential wall portion or an inner circumferential surface of the housing.

29. The motor according to claim 24, wherein a front surface of the overhang portion is an inclined surface which is displaced rearward as it heads radially outward.

30. The motor according to claim 11, wherein gas flows into the casing through the through-hole due to rotation of the rotating portion.
